(19) United States
(12) Patent Application Publication
(10) Pub. No.: US 2014/0324918 A1
(43) Pub. Date: Oct. 30, 2014

(54) Database Generation System, Method For Generating A Database, Product Line Management System And Non-Transitory Data Carrier

(71) Applicant: Siemens Aktiengesellschaft, Munchen (DE)

(72) Inventor: Naoufel Boulila, Munchen (DE)

(21) Appl. No.: 13/909,688

(22) Filed: Jun. 4, 2013

(30) Foreign Application Priority Data
Apr. 29, 2013 (EP) 13165801

(51) Int. Cl. G06F 17/30

(52) U.S. Cl. CPC G06F 17/30292
USPC 707/803

(57) ABSTRACT

The task of generating a product line database may be automated by automatically analysing product line models which comprise a representation of the respective product line. The final product can be a physical product, e.g., a mobile telephone, a software product, etc. A representation of the produce line is generated from the product line models, which represents all products, features, platform, variants and their requirements of the respective product line. The database generator then uses and parses said representation to generate a database module, which can be incorporated into a specified database management system. When the database module is incorporated into a database management system it populates the database to contain all the relevant data of the product line model. This procedure automates the procedure of transforming product line related information from a model representation into a database module that can be directly imported into a specific database management system.

### CROSS-REFERENCE TO RELATED APPLICATIONS

This application claims priority to EP Patent Application No. 13165801.5 filed Apr. 29, 2013. The contents of which is incorporated herein by reference in its entirety.

### TECHNICAL FIELD

This disclosure relates to a database generation system for use in a product line management system. The present disclosure, furthermore, relates to a respective method for generating a database, a respective product line management system and a respective non-transitory data carrier.

### BACKGROUND

Although applicable to any database system, the present invention will be described in combination with product line management systems.

Today's industries need to cope with the increasing needs and challenges in a consumer market (e.g. mobile devices such as smartphones, multimedia devices, and the like) as well as in the global market (light and heavy manufacturing industries) in the fields of product line engineering (PLE) and product line management. Consequently, there is high interest in developing and managing PLE methods and tools in particular for PLE requirements.

Managing product lines for software and systems is a complex and difficult task. During domain engineering, variability is introduced in all domain engineering artefacts (requirements, architecture, components, test cases, etc.). The variability is exploited during application engineering to derive applications tailored to the specific needs of different customers. This PLE development process is shown in detail in FIG. 8.

During domain engineering or domain requirements engineering, the domain requirements engineering sub-process encompasses all activities for eliciting and documenting the common and variable requirements of the product line. The input for this sub-process comprises the product roadmap. The output comprises reusable, textual and model-based requirements and, in particular, the variability model of the product line or the product line model. Hence, the output does not include the requirements specification of a particular application, but the common and variable requirements for all foreseeable applications of the product line. An exemplary flow chart of such a domain requirements engineering process is shown in FIG. 9.

During domain requirements engineering, PLE domain engineers and developers need to precisely identify the single variants for each product in the product line, analyse the requirements to identify those that are common to all applications and those that are specific for particular applications (i.e. that differ among several applications).

These crucial activities, among others, lead to the development of variability and commonality models (also called feature models, see FIG. 8) including:
all common software or system product features that form the basis for the PLE platform (commonalities)
all variants and variation points of the software or system product (variabilities)

In a later step, all commonalities and variants including their requirements elements have to be categorized and documented and finally inserted in a database to enable further various development activities including requirements management during the product development life cycle. This is usually done by hand by the developers of the product line model.

Accordingly, there is a need to simplify the database generation in product line management systems.

### SUMMARY

According to a first aspect the present invention provides a database generation system for use in a product line management system for managing at least one product line, comprising:
a model input interface configured to receive at least one product line model, the product line model comprising a model of the at least one product line;
a model processor configured to automatically analyse the at least one received product line model and extract a representation of the at least one product line from the at least one received product line model; and
a database generator configured to generate from the extracted representation a database module which comprises a database structure of the at least one product line.

According to a second aspect the present invention provides a method for generating a database for use in a product line management system for managing at least one product line, comprising the steps:
receiving at least one product line model, the product line model comprising a model of the at least one product line;
building automatically a representation of the at least one product line from the at least one received product line model; and
generating from the built representation a database module which comprises a database structure of the at least one product line.

According to a third aspect the present invention provides a product line management system for managing at least one product line, comprising:
a database generation system, the database generation system comprising:
   a model input interface configured to receive at least one product line model, the product line model comprising a model of the at least one product line;
   a model processor configured to automatically analyse the at least one received product line model and extract a representation of the at least one product line from the at least one received product line model; and
   a database generator configured to generate from the extracted representation a database module which comprises a database structure of the at least one product line.

According to a fourth aspect the present invention provides a non-transitory data carrier comprising a computer program which when executed by a processor causes the processor to:
receive at least one product line model, the product line model comprising a model of the at least one product line;
build a representation of the at least one product line from the at least one received product line model; and
generate automatically from the built representation a database module which comprises a database structure of the at least one product line.

The present invention is based on the conclusion that the activity of documenting the product requirements is a long and difficult and error prone task. This is because the development of feature and requirements models can produce huge models with hundreds or thousands of commonalities and variants. Thus, preserving the logical structure of the requirements as well as the product features and granularity to transfer it to a database is practically unfeasible.

Therefore, the present invention uses this knowledge to automate the process of creating and populating a database containing products, features, a platform, variants and their requirements from analysis models including feature models of a specific product line.

The present invention accomplishes this automation by automatically analysing product line models which comprise a representation of the respective product line. The product line can be a product line of any kind. The final product can be a physical product, like e.g. a mobile telephone. But, the final product can also be a software product.

From this product line models the present invention then generates a representation of the product line.

The representation according to the present invention is a representation of all products, features, platform, variants and their requirements of the respective product line. The representation can be embodied as a textual representation. The representation can also be embodied as a XML-based and/or a tree-based or any other data structure representation.

Especially, the representation is embodied in a form that can efficiently be parsed by the database generator of the present invention.

The database generator then uses and parses said representation to generate a database module, which can be incorporated into a specified database management system. The database module is generated such that when it is incorporated into a database management system it populates the database to contain all the relevant data of the product line model.

With this features the present invention automates the procedure of transforming product line related information, like features, variants base requirements or the like, form a model representation into a database module, which can directly be imported into a specific database management system.

The database management system can be any database management system. In one embodiment the database management system can be a requirements specific database management system, like e.g. DOORS.

Further embodiments of the present invention are disclosed in the following description, referring to the drawings.

In a possible embodiment the model processor comprises a model analyser, which is configured to extract from the product line model at least one product name and/or at least one feature and/or a platform and/or at least one variant and/or requirements information and store the extracted at least one product name and/or the at least one feature and/or the platform and/or the at least one variant and/or the requirements information in the representation. This allows effectively extracting the relevant information from the product line model.

In a possible embodiment the model analyser is configured to analyse product line models provided in a UML format and/or a XML-based format and/or a text-based format. By using a standardized and/or human readable format for the product line model the creation of the product line model as well as the analysis of the product line model can be done with freely or easily available tools.

In a possible embodiment the model analyser is configured to sort the extracted at least one product name and/or the at least one feature and/or the platform and/or the at least one variant and/or the requirements information in lists and/or structured tree data structures. Lists and/or structured tree data structures provide fast and easy access to all elements which are stored in said lists or structured tree data structures.

In a possible embodiment the model analyser is configured to automatically couple every mandatory element of the product line model to the platform. The coupling is in a possible embodiment is done by providing a reference to a platform in the data of said mandatory elements. This allows searching and or referencing all elements, which belong to the same platform.

In a possible embodiment the model analyser is configured to automatically couple every optional element of the product line model to at least one product name. The coupling is done in a possible embodiment by providing a reference to a product name in the data of the optional elements. This allows virtually assembling a specific product and easily accessing all the data related to the product.

In a possible embodiment the database generator comprises a data processor, which is configured to process the representation and generate a database schema and/or a hierarchy structure and/or a requirements management specific module based on the processed representation. Generating the database schema and/or hierarchy structure and/or requirements management specific module allows creating only the required artefacts which are needed to later generate the database module.

In a possible embodiment the data processor when generating the database schema is configured to generate the database schema for a predetermined database management system. This allows adapting the database module generation to a specific database, and, furthermore, easily exchanging the target database without the need of re-generating all the necessary information. When the target database is exchanged, only the database schema has to be re-generated.

In a possible embodiment the data processor when generating the hierarchy structure is configured to generate the hierarchy structure as a mapping of the element structure of the product line model. This allows a detailed mapping of the product line into the database.

In a possible embodiment the data processor when generating the requirements management specific module is configured to generate the requirements management specific module for a predetermined requirements management system. This allows integrating the database module not only into general database management systems but also into specific requirements management systems, like e.g. DOORS.

In a possible embodiment the database generator comprises a database module generator which is configured to generate the database module from the database schema and/or the hierarchy structure and/or the requirements management specific module. Providing a database generator which is configured to generate the database module based on the database schema and/or the hierarchy structure and/or the requirements management specific module allows a very flexible generation of the database module.

### BRIEF DESCRIPTION OF THE DRAWINGS

For a more complete understanding of the present invention and advantages thereof, reference is now made to the following description taken in conjunction with the accompanying drawings. The invention is explained in more detail below using exemplary embodiments which are specified in the schematic figures of the drawings, in which:

FIG. 1 shows a block diagram of an embodiment of a database generation system according to the first aspect of the present invention;

FIG. 2 shows a flow diagram of an embodiment of a method according to the second aspect of the present invention;

FIG. 3 shows a block diagram of an embodiment of a product line management system according to the third aspect of the present invention;

FIG. 4 shows a block diagram of another embodiment of a database generation system according to the first aspect of the present invention;

FIG. 5 shows a flow diagram of another embodiment of a method according to the second aspect of the present invention;

FIG. 6 shows a block diagram explaining the mapping of a product line model;

FIG. 7 shows the mapping of product line model data to a hierarchy structure;

FIG. 8 shows a block diagram of a PLE development process;

FIG. 9 shows a block diagram of a domain requirements engineering process.

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily drawn to scale relative to each other. Like reference numerals designate corresponding similar parts.

### DETAILED DESCRIPTION OF THE DRAWINGS

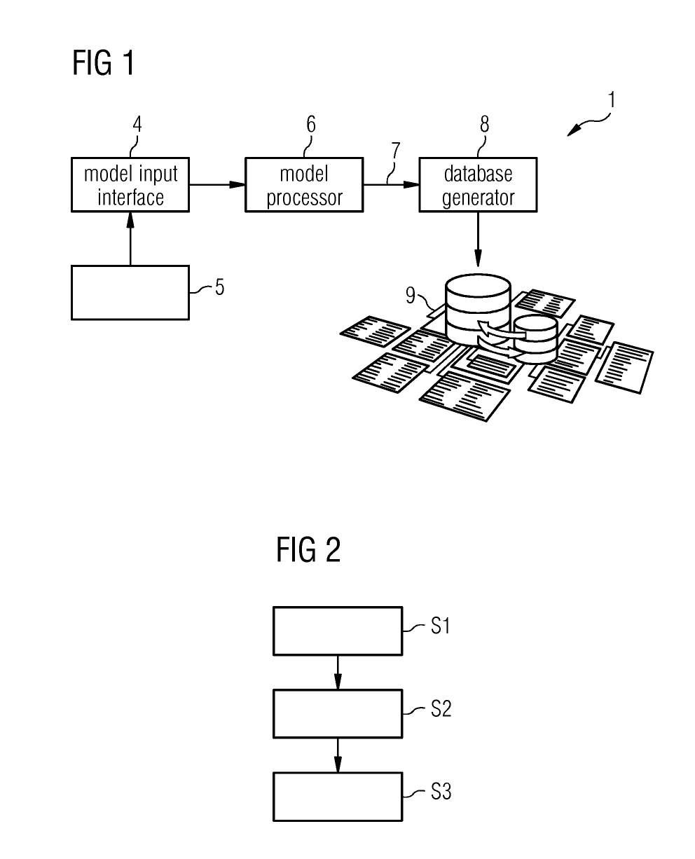

FIG. 1 shows a block diagram of an embodiment of a database generation system 1 according to the first aspect of the present invention.

The database generation system 1 in FIG. 1 comprises a model input interface 4 which is coupled to a model processor 6. The model processor 6 is coupled to a database generator 8.

The model input interface 4 receives a product line model 5 and provides the product line model 5 to the model processor 6.

The product line model 5 can be a UML model of the product line, which comprises a model representation of a product line 3. The product line 3 can for example be a product line 3 of an industrial automation system. The product line model 5 comprises all information about the industrial automation system, like e.g. product names 11, features 12, variants 14, a platform 13 and requirements information 15 as also illustrated in FIG. 4.

The platform 13 describes any base technology on top of which the product line 3, in this case the industrial automation system, is built.

The product line model 5 can comprise all common features of all products of a product line 3, also called commonalities, and all the product specific, variable features, the so called variabilities.

Typically, the product line model 5 is built during a domain engineering phase of product development.

The model processor 6 automatically analyses the received product line model 5 and extracts a representation 7 of the product line 3 from the received product line model 5.

The representation according to the present invention is a representation of all product names 11 or products, features 12, the platform 13, variants 14 and their requirements 15 of the respective product line 3.

Finally, the database generator 8 generates from the extracted representation 7 a database module 9.

The database module 9 comprises a database structure of the product line 3, in this case the industrial automation system.

FIG. 2 shows a flow diagram of an embodiment of a method according to the second aspect of the present invention.

The method comprises a receiving step S1 to receive at least one product line model 5. The product line model 5 comprises a model of the at least one product line 3. In a further step S2 a representation 7 of the at least one product line 3 is built from the at least one received product line model 5. Finally, the method generates in step S3 automatically from the built representation 7 a database module 9 which comprises a database structure of the at least one product line 3.

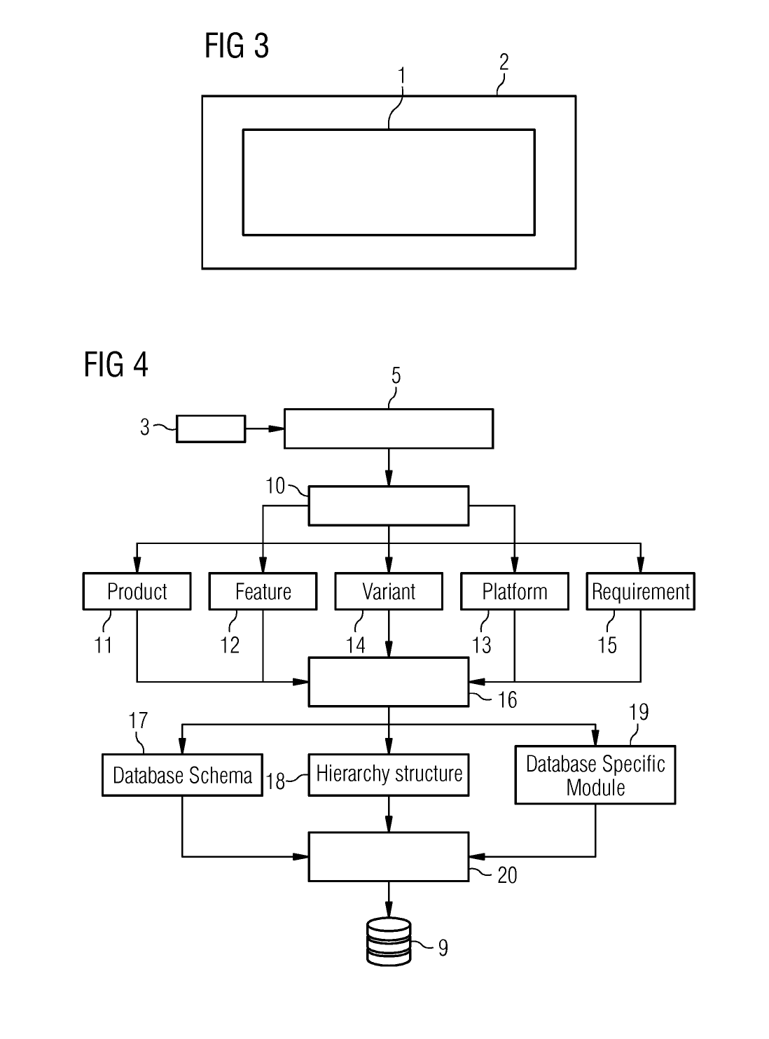

FIG. 3 shows a block diagram of an embodiment of a product line management system 2 according to the third aspect of the present invention.

The product line management system 2 is configured for managing at least one product line 3 and comprises a database generation system 1 according to the first aspect of the present invention.

Consequently, the database generation system 1 comprises at least a model input interface 4 configured to receive at least one product line model 5, which comprises a model of the at least one product line 3. The system further comprises a model processor 6 configured to automatically analyse the at least one received product line model 5 and to extract a representation 7 of the at least one product line 3 from the at least one received product line model 5, and a database generator 8 configured to generate from the extracted representation 7 a database module 9 which comprises a database structure of the at least one product line 3.

FIG. 4 shows a block diagram of another embodiment of a database generation system 1 according to the first aspect of the present invention.

The database generation system 1 of FIG. 4 is based on the database generation system 1 of FIG. 1, wherein the model processor 6 comprises a model analyser 10 and the database generator 8 comprises a data processor 16 and a database module generator 20.

For reasons of clarity the model processor 6 and the database generator 8 are not explicitly shown in FIG. 4

The model analyser 10 is configured to automatically extract from the product line model 5 which represents the product line 3 at least one product name 11, at least one feature 12, a platform 13, at least one variant 14 and/or requirements information 15. The model analyser 10 is further configured to store the extracted at least one product name 11, at least one feature 12, a platform 13, at least one variant 14 and/or requirements information 15 in the representation 7.

In an embodiment the model analyser 10 is configured to analyse product line models 5 provided in a UML format and/or a XML-based format and/or a text-based format.

In a further embodiment the model analyser 10 is configured to sort the extracted at least one product name 11, at least one feature 12, a platform 13, at least one variant 14 and/or requirements information 15 in lists and/or structured tree data structures. The model analyser 10 can be configured to automatically couple every mandatory element 21 of the product line model 5 to the platform 13. In a possible embodiment the model analyser 10 is configured to automatically couple every optional element 22 of the product line model 5 to at least one product name 11.

The data processor 16 is configured to process the representation 7 and generate a database schema 17 and/or a hierarchy structure 18 and/or a requirements management specific module 19 based on the processed representation 7.

In a possible embodiment the data processor 16 when generating the database schema 17 is configured to generate the database schema 17 for a predetermined database management system. The data processor 16 when generating the hierarchy structure 18 can be configured to generate the hierarchy structure 18 as a mapping of the element structure of the product line model 5.

In one embodiment the data processor 16 when generating the requirements management specific module 19 is configured to generate the requirements management specific module 19 for a predetermined requirements management system. In another embodiment the database module generator 20 is configured to generate the database module 9 from the database schema 17, the hierarchy structure 18, and/or the requirements management specific module 19.

FIG. 5 shows a flow diagram of a further embodiment of a method according to the second aspect of the present invention.

The method of FIG. 5 is based on the method of FIG. 2 and comprises additional steps.

The step S2 of building a representation 7 of the at least one product line 3 from the at least one received product line model 5 comprises the following further sub steps:

Extracting in step S4 from the product line model 5 at least one product name 11 and/or at least one feature 12 and/or a platform 13 and/or at least one variant 14 and/or requirements information 15, and storing in step S5 the extracted at least one product name 11 and/or the at least one feature 12 and/or the platform 13 and/or the at least one variant 14 and/or the requirements information 15 in the representation 7.

The step S4 of extracting can furthermore comprise sorting in step S6 the extracted at least one product name 11, the at least one feature 12, the platform 13, the at least one variant 14 and/or the requirements information 15 in lists and/or structured tree data structures.

The step S4 of extracting can also comprise automatically coupling in step S7 every mandatory element 21 of the product line model 5 to the platform 13, and automatically coupling in step S8 every optional element 22 of the product line model 5 to at least one product name 11.

Furthermore, the step S3 of generating automatically from the built representation 7 a database module 9 which comprises a database structure of the at least one product line 3 comprises the further sub-step S9 of building a database schema 17 and/or a hierarchy structure 18 and/or a requirements management specific module 19 based on the representation 7.

Furthermore, in the step S9 of building the database schema 17 comprises generating in sub-step S10 the database schema 17 for a predetermined database management system and generating in sub-step S11 the hierarchy structure 18 as a mapping of the element structure of the product line model 5. Furthermore, the step S9 of building the requirements management specific module 19 comprises the sub-step S12 of generating the requirements management specific module 19 for a predetermined requirements management system.

Finally, the step S3 of generating comprises the step S13 of generating the database module 9 from the database schema 17 and/or the hierarchy structure 18 and/or the requirements management specific module 19.

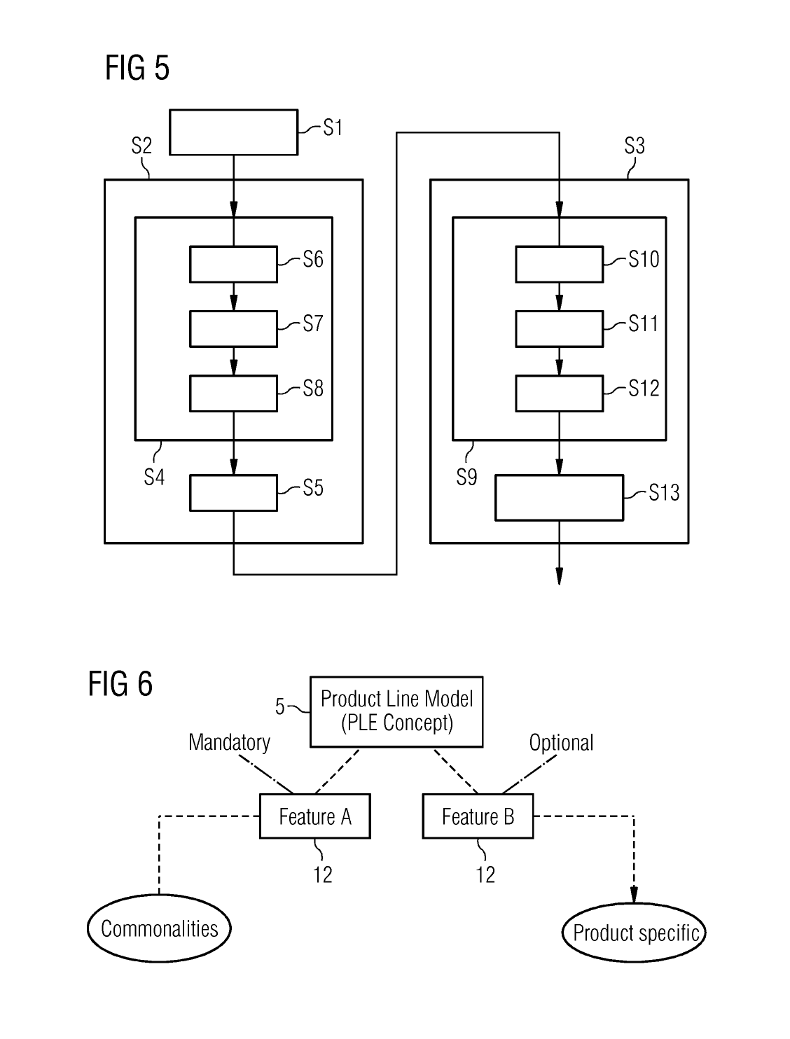

FIG. 6 shows a block diagram explaining the mapping of a product line model 5, also called a PLE concept 5 or Product Line Engineering concept 5, to commonalities (all common software or system product features that form the basis for the PLE platform) and to product specific features or variabilities.

From FIG. 6 it becomes clear that all mandatory features 12 which are described in a product line model 5 belong to the commonalities and that all optional features which can be included in specific products of the product line 3 belong to the variabilities or product specific features.

In an embodiment the product line 3 can be for example a smartphone product line 3.

The smartphone product line 3 can for example comprise common features (commonalities) for all products of the product line 3, like for example a case, a speaker, a microphone, a main processor, RAM and a SIM card slot.

The smartphone product line 3 can also include at least two smart phone models with the product names 11 “SM1” and “SM2”. The variabilities for the product “SM1” can e.g. include a second SIM card slot and a Bluetooth adapter. In a similar fashion the variabilities for the product “SM2” can include a flash memory and a SD-card slot.

In the database module 9 for the above described smartphone product line 3 the case, the speaker, the microphone, the main processor, the RAM and the SIM card slot can be coupled to the platform 13 of the smartphone product line 3.

The second SIM card slot and the Bluetooth adapter can be coupled to the first variant “SM1” of the smartphone product line 3. And finally, the flash memory and the SD-card slot can be coupled to the second variant “SM2” of the smartphone product line 3.

Consequently, in any further development of the smartphone product line 3 every smartphone would include the case, the speaker, the microphone, the main processor, the RAM and the SIM card slot.

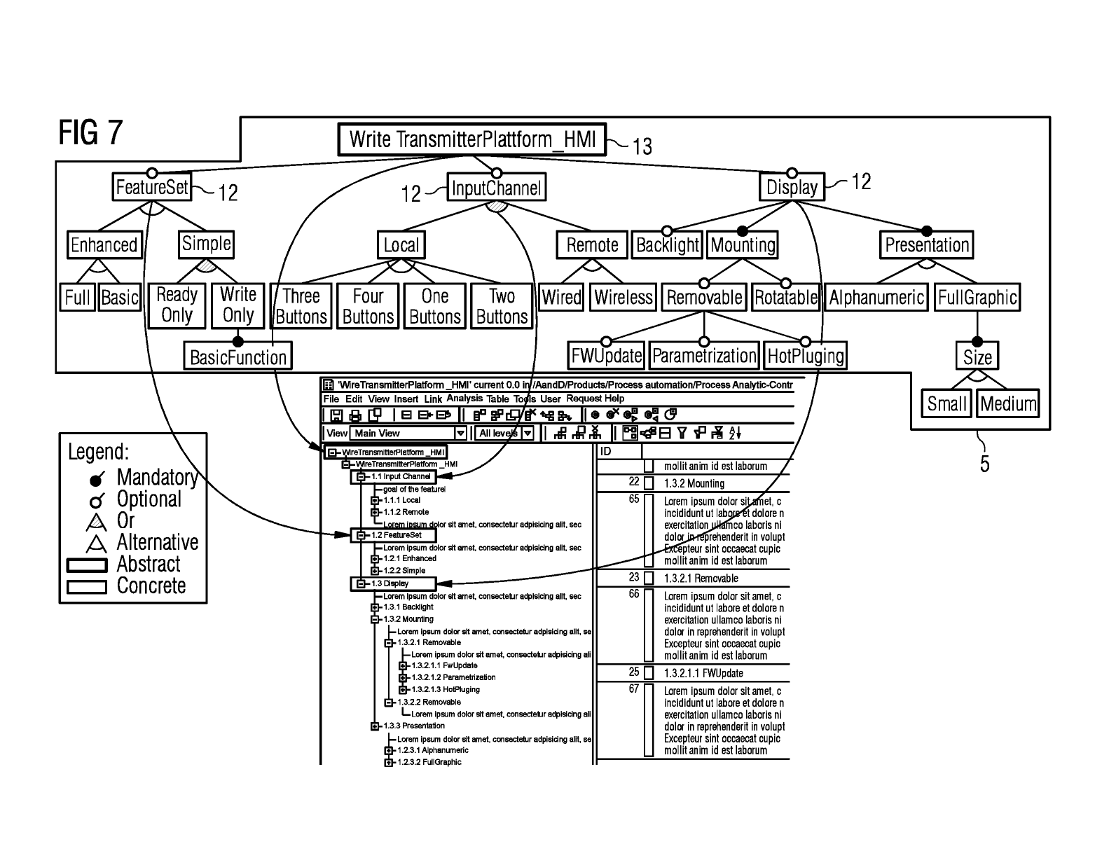

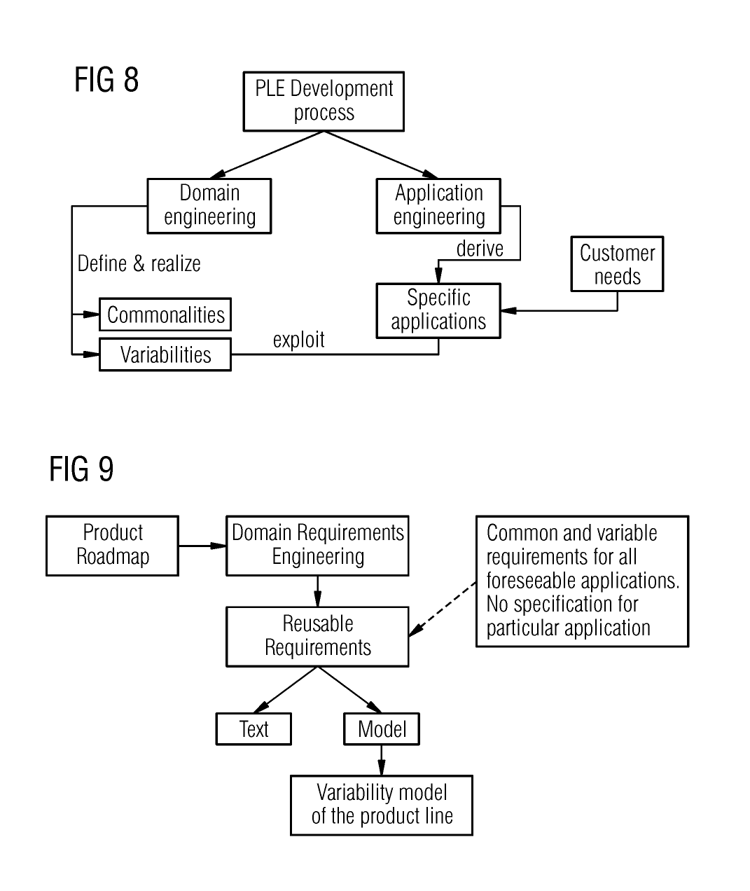

FIG. 7 shows the mapping of the product line model data to a hierarchy structure.

In FIG. 7 the product line model 5 comprises a plurality of different features 12 or product line features 12. The features 12 in FIG. 5 are organised in a tree-like fashion, wherein every features 12 can have subordinate features 12. Not every feature has been referenced with reference sign 12 for reasons of clarity of FIG. 7. The product line model 5 is accompanied by a legend, which shows that subordinate features can be mandatory or optional. Furthermore, subordinate features can be exclusive (Alternative) or can be concurrent (OR). Finally, product line features 12 can be marked as abstract or concrete.

Below the picture of product line model 5 a screenshot of a database management software is displayed, in which the product line model 5 has been transferred to a hierarchical database structure.

In the screenshot of FIG. 7 it can be seen, that the tree like structure is transferred to the database structure by placing the subordinate features 12 in the database below the respective higher features 12 resulting in an exact copy of the tree like product line model 5 as a structured list in the database structure.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In the foregoing detailed description, various features are grouped together in one or more examples or examples for the purpose of streamlining the disclosure. It is understood that the above description is intended to be illustrative, and not restrictive. It is intended to cover all alternatives, modifications and equivalents as may be included within the scope of the invention. Many other examples will be apparent to one skilled in the art upon reviewing the above specification.

Specific nomenclature used in the foregoing specification is used to provide a thorough understanding of the invention.

However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

1. A database generation system for use in a product line management system for managing at least one product line, comprising:
a model input interface configured to receive at least one product line model, the product line model comprising a model of the at least one product line;
a model processor configured to automatically analyse the at least one received product line model and extract a representation of the at least one product line from the at least one received product line model; and
a database generator configured to generate from the extracted representation a database module which comprises a database structure of the at least one product line.

2. The database generation system of claim 1, wherein the model processor comprises a model analyser configured to
automatically extract from the product line model information including at least one of: at least one product name, at least one feature, a platform, at least one variant, and requirements information, and
store the extracted information in the representation.

3. The database generation system of claim 2, wherein the model analyser is configured to analyse product line models provided in at least one of a UML format, a XML-based format, and a text-based format.

4. The database generation system of claim 2, wherein the model analyser is configured to sort the extracted information in lists or structured tree data structures.

5. The database generation system of claim 2, wherein the model analyser is configured to automatically couple every mandatory element of the product line model to the platform.

6. The database generation system of claim 2, wherein the model analyser is configured to automatically couple every optional element of the product line model to at least one product name.

7. The database generation system of claim 1, wherein the database generator comprises a data processor, which is configured to process the representation and generate at least one of a database schema, a hierarchy structure, and a requirements management specific module based on the processed representation.

8. The database generation system of claim 7, wherein the data processor is configured to, when generating the database schema, generate the database schema for a predetermined database management system.

9. The database generation system of claim 7, wherein the data processor is configured to, when generating the hierarchy structure, generate the hierarchy structure as a mapping of the element structure of the product line model.

10. The database generation system of claim 7, wherein the data processor is configured to, when generating the requirements management specific module, generate the requirements management specific module for a predetermined requirements management system.

11. The database generation system of claim 7, wherein the database generator comprises a database module generator which is configured to generate the database module from the at least one of the database schema, the hierarchy structure, and the requirements management specific module.

12. A method for generating a database for use in a product line management system for managing at least one product line, comprising:
receiving at least one product line model, the product line model comprising a model of the at least one product line;
building a representation of the at least one product line from the at least one received product line model; and
generating automatically from the built representation a database module which comprises a database structure of the at least one product line.

13. The method of claim 12, wherein building comprises:
extracting from the product line model information including at least one of: at least one product name, at least one feature, a platform, at least one variant, and requirements information; and
storing the extracted information in the representation.

14. The method of claim 13, wherein extracting comprises sorting the extracted information in lists or structured tree data structures.

15. The method of claim 13, wherein extracting comprises automatically coupling every mandatory element of the product line model to the platform.

16. The method of claim 13, wherein extracting comprises automatically coupling every optional element of the product line model to at least one product name.

17. The method of claim 12, wherein generating comprises building at least one of a database schema, a hierarchy structure, and a requirements management specific module based on the representation.

18. The method of claim 17, wherein building the database schema comprises generating the database schema for a predetermined database management system.

19. The method of claim 17, wherein building the hierarchy structure comprises generating the hierarchy structure as a mapping of the element structure of the product line model.

20. The method of claim 17, wherein building the requirements management specific module comprises generating the requirements management specific module for a predetermined requirements management system.

21. The method of claim 17, wherein generating comprises generating the database module from the at least one of the database schema, the hierarchy structure, and the requirements management specific module.

22. A product line management system for managing at least one product line, comprising:
a database generation system, the database generation system comprising:
a model input interface configured to receive at least one product line model, the product line model comprising a model of the at least one product line;
a model processor configured to automatically analyse the at least one received product line model and extract a representation of the at least one product line from the at least one received product line model; and
a database generator configured to generate from the extracted representation a database module which comprises a database structure of the at least one product line.

23. A non-transitory data carrier comprising a computer program which when executed by a processor causes the processor to:
receive at least one product line model, the product line model comprising a model of the at least one product line;
build a representation of the at least one product line from the at least one received product line model; and
generate automatically from the built representation a database module which comprises a database structure of the at least one product line.
